(19) United States
(12) Patent Application Publication
(10) Pub. No.: US 2018/0160666 A1
(43) Pub. Date: Jun. 14, 2018

(54) Apparatus for removing twist from fishing line

(71) Applicant: Bruce Lee, Rappahannock Acade, VA (US)

(72) Inventor: Bruce Lee, Rappahannock Acade, VA (US)

(21) Appl. No.: 15/530,193

(22) Filed: Dec. 12, 2016

(51) Int. Cl. A01K 91/06

(52) U.S. Cl. CPC A01K 91/06

(57) ABSTRACT

A simple device that enables twisted fishing line to be easily untwisted is disclosed. The device comprises a shaft surrounded with a helical groove or channel around which fishing line passes while being loaded onto a fishing reel. The helical grooves or channels remove twist from the fishing line caused by a rotating bail on a fixed spool reel. The device can be used with any reel, but is particularly well adapted for fixed spool spinning or fixed spool spin-cast reels.

### CROSS REFERENCE TO RELATED APPLICATIONS

None

### STATEMENT REGARDING FEDERALLY SPONSORED RESEARCH OR DEVELOPMENT

Not Applicable

### THE NAMES OF PARTIES TO A JOINT RESEARCH AGREEMENT

None

### INCORPORATION-BY-REFERENCE OF MATERIAL SUBMITTED ON A COMPACT DISK

None

### BACKGROUND OF THE INVENTION

Those who enjoy the sport of fishing with rods and reels have often encountered tangled and twisted fishing lines. Twisting of the fishing line is a natural by-product of the use of well-known fishing reels having a spool member onto which the fishing line is wound. Typically, a well-known manual crank is used to operate a mechanism that winds the fishing line onto the spool member. With some versions of fishing reels, the manual crank causes the spool member to rotate, thereby causing the fishing line to become wound onto the spool of the reel. With other versions of fishing reels, commonly known as “spinning reels”, a bail member revolves around a non-rotating spool member in response to operation of the manual crank, and the bail member winds the fishing line around the non-rotating spool. As a lure attached to the end of the fishing line is cast and retrieved, the winding and unwinding of the fishing line around the spool of the fishing reel causes the line to be twisted in either a clockwise or counter-clockwise direction, depending on the specific structure of the fishing reel. Additional line twisting may occur due to rotation of the lure as it is retrieved through the water or when landing a fish pulling on the drag. It should be understood that twisting of the fishing line is most prevalent and severe when spinning reels are used, but some limited twisting of the fishing line can also occur because of the structure of other types of fishing reels as well. Various fishing habits and techniques of individual fishermen may also contribute to the direction of accumulated line twist. Twisted fishing line reduces the enjoyment of fishing and causes difficulties in casting and retrieving a lure attached to the fishing line. Entanglement and knotting of the fishing line also occurs, rendering the line useless. Often, a length of twisted fishing line is simply cut from the spool and discarded or the entire line is replaced with a new line. Continual replacement of old line with new line creates an environmental hazard because the line often is disposed of into the environment endangering fish and wildlife.

It is therefore desirable to have apparatus and methods for quickly and easily removing the twist in fishing line without removal of the fishing lure from the fishing line and without frequent sacrificing of a portion of twisted fishing line.

### BRIEF SUMMARY OF THE INVENTION

Applicant has designed a simple device that enables twisted fishing line to be easily untwisted. The device comprises a shaft surrounded with a helical groove or channel around which fishing line passes while being loaded onto a fishing reel. The helical grooves or channels remove twist from the fishing line caused by a rotating bail on a fixed spool reel. The device can be used with any reel, but is particularly well adapted for fixed spool spinning or fixed spool spin-cast reels.

The invention can be used while fishing with or without removal of the lure; or it can be used after the day is done. The user simply makes a long cast and then pulls out an additional ten to twenty feet of line. Line is retrieved through the helical grooves of the device, rewinding onto the reel spool, removing the line twist.

The device removes twist from fishing line while fishing line is retrieved onto a spinning reel, comprising an elongated rod with a distal end and a proximal end including a helical groove extending around the elongated rod, from the distal end to the proximal end. When fishing, line passes around the helical groove, twisting the fishing line in an equal and opposite manner from the twist imparted by the rotation of the spinning reel, thereby removing twist from the line.

The device further includes at least one split ring adapted to overlie the elongated rod and the helical groove, thereby enabling the fishing line to be secured in the helical groove between the elongated rod and the split ring.

The elongated rod has at least one journal and the least one split ring is adapted to snap into the at least one journal, over the elongated rod. Preferably the helical ring is deeper than the journal, enabling the fishing line to pass between the split ring and the elongated rod.

Further, a hook can be attached to the proximal end of the device whereby the device can be removably secured to a fishing rod, enabling a user to remove twist in fishing line while engaged in fishing.

In another embodiment he device includes two removable clamps adapted to surround the cylindrical rod and the fishing rod thereby securing the device to a fishing rod, while simultaneously securing the fishing line in the helical groove between the removable clamps and the cylindrical rod. A slot is provided in each of the two clamps that enable fishing line to pass between the two clamps and the cylindrical rod, wherein fishing line can be retrieved over the cylindrical rod without removing the fishing line from the rod guides.

### BRIEF DESCRIPTION OF THE DRAWINGS

FIG. 1 shows the line loading device according to the invention, with a helical groove wrapped around a rod or shaft. The grooves are adapted to load fishing line onto a spinning reel while simultaneously removing twist.

FIG. 2 shows the 1 line loading device clamped to a fishing rod.

FIG. 3 shows the embodiment of FIG. 2 as it appears viewing along the axis of symmetry of a fishing rod.

FIG. 4 shows the preferred embodiment of the line loading device including a hook that attaches to the guide of a fishing rod.

FIG. 5 shows the embodiment of FIG. 4 with circular clamps, disassembled from the line loading device, that secure fishing line into grooves on the surface of the line loading device.

FIG. 6 shows the embodiment of FIG. 4 in cross-section.

FIG. 7 shows the circular clamp of FIG. 5 as it appears in profile.

FIG. 8 shows the line loading device attached to a fishing line.

### DETAILED DESCRIPTION OF THE INVENTION

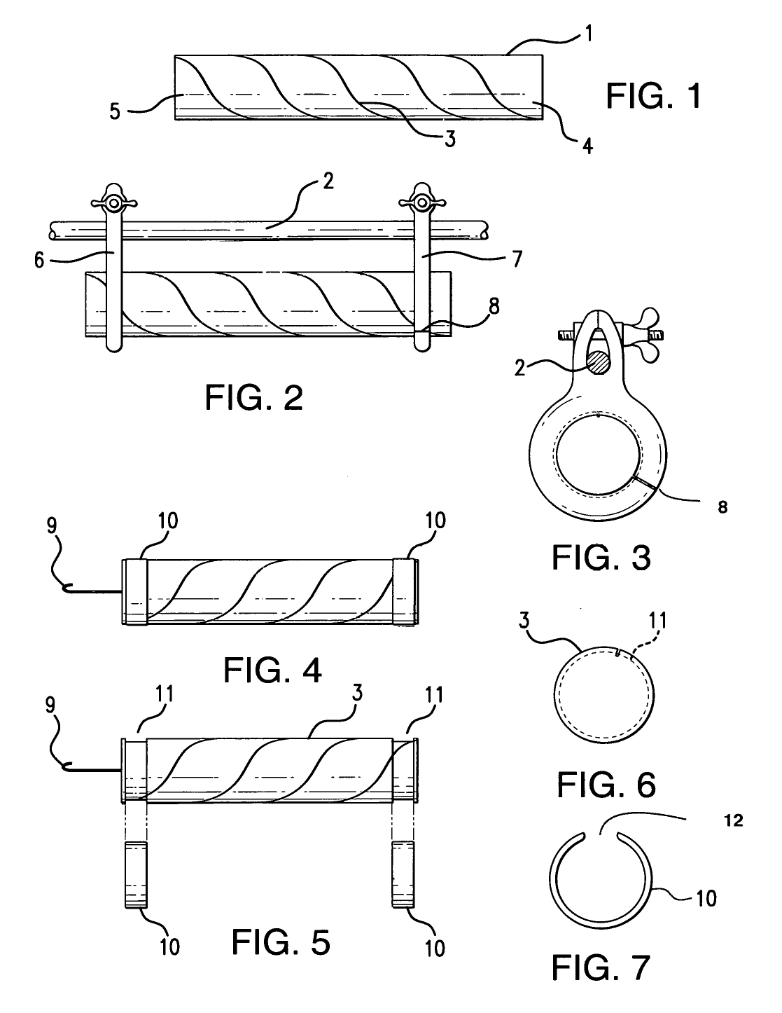

Referring to FIG. 1 cylindrical rod (1) is designed to be clamped to fishing rod (2), as shown in FIG. 2. Although a cylindrical rod is shown, it is expressly understood that the rod or shaft (1) can be manufactured in any suitable shape, such as hexagonal, octagonal, or even square in cross section. Any suitable clamping means is considered within the scope of the invention. Particular clamping means will be discussed in more detail below. Cylindrical rod (1) can be clamped between the last guide on fishing rod (2), closest to the spinning reel, and the spinning reel. However it has been discovered that the invention works well when cylindrical rod (1) is positioned between two guides of the fishing rod (2).

A helical groove (3) is located on the outer surface of cylindrical rod (1). Helical groove (3) wraps around the entire surface of cylindrical rod (1). It is important that helical groove (3) be clockwise rather than counter clockwise. When line is retrieved while fishing the line is twisted in a counter clockwise rotation. However, if the reel bail turns in the opposite direction from conventional reels, the helical groove should be counter clockwise. When cylindrical rod (1) is to be clamped between the last guide on fishing rod (2), closest to the spinning reel, and the spinning reel, it is important that the terminal end (4) of the helical groove (3) located on the distal end of cylindrical rod (1), facing the fishing reel, be in proper alignment with the spool of the spinning reel. When distal terminal end (4) is properly aligned, fishing line will smoothly transition from the invention onto the spinning reel when the line is wound onto the reel spool. Likewise proximal terminal end (5) of the helical groove facing the first guide of the fishing rod should align with the first guide of the fishing rod such that fishing line will smoothly wind around helical groove (3). Helical groove (3) need be no deeper than a few diameters of the fishing line. However, it has been found that the depth of helical groove (3) is optimally between ⅛ and ¼ of an inch in depth. When cylindrical rod (1) is used between two spinning rod guides, the exact location of the terminal ends of helical groove (3) is less critical.

As seen in FIGS. 2 and 3, rings (6) and (7) can be located at distal end (4) and proximal end (5) of the cylindrical rod or shaft. The purpose of rings (6) and (7) is to prevent the fishing line from slipping off the helical groove (3) as line is wound onto the fishing reel, and to secure the line loading device to the fishing rod. Any convenient type of ring is usable; however rings that are removable are particularly well adapted to use in combination with the grooved cylindrical rod (1). As shown in FIG. 2 slot (8) allows fishing line to pass under rings (6) and (7) and be aligned in the helical groove (3), such that the fishing line passes between rings (6) and (7) and cylindrical rod (1). Slot (8) must be provided on both rings (6) and (7) to enable the fishing line to be aligned in helical groove (3) without removing the fishing line from the guides of the fishing rod. Slot (8) may be on the visible slue of rings (6) and (7), as seen in FIGS. 2 and 3, on the distal end (4) of ring (7) or on the rear invisible side of rings (6) and (7), as seen on the proximal end (5) on ring (6).

Any suitable clamping mechanism can be utilized to attach cylindrical rod (1) to a spinning rod. For instance, as seen in FIGS. 2 and 3, clamps (6) and (7) are adapted to surround both the spinning rod and the cylindrical rod (1). Clamps (6) and (7) can be fastened with wing-nuts. Clamps (6) and (7) can be opened, placed over cylindrical rod (1), with spinning line within helical groove (3) and then closed to secure cylindrical rod (1) to the spinning rod. Because rings (6) and (7) closely surround the terminal ends of cylindrical rod (1), the spinning line is maintained within helical groove (3). Of course a slot (8) must be provided to allow fishing line to be slipped under clamps (6) and (7) such that the fishing line can be aligned in the helical groove (3). After the fishing line is slipped through groove (8) and aligned with the helical groove (3), cylindrical rod (1) can be rotated to prevent the fishing line from escaping through groove or slot (8). Then the wing nuts can be tightened absolutely securing the combination to the fishing rod.

The exact length of cylindrical rod (1) is determined by the amount of fishing line wound onto the spinning reel spool per revolution of the spinning reel bail. When the length of the cylindrical rod is properly matched to the particular spinning reel, the fishing line will be twisted equal and opposite to the twist imparted by the spinning reel bail when the fishing line passes around the helical groove. Equally important is the direction of the helical grooves. A clockwise direction for the helical grooves is appropriate for the direction of rotation of the conventional spinning reel.

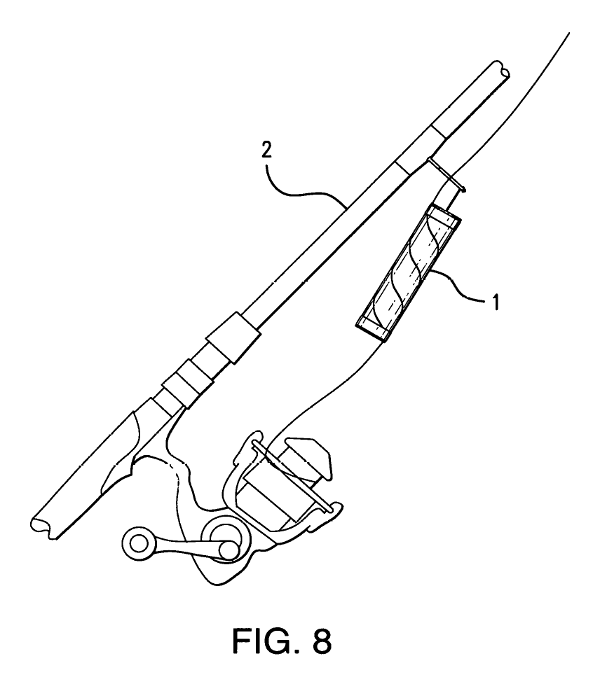

FIG. 4 shows the preferred embodiment of the invention where the cylindrical line device is provided with a hook (9) that removably attaches to the fishing rod guide, as seen best in FIG. 8. Hook (9) can attach to the ring portion of the fishing rod guide or to the feet of the guide. Two split rings (10) are journaled at (11) into the proximal and distal ends of the line device. Each of the split rings (10) has slots (12) to allow rings (10) to open and to be snapped into journals (11). FIG. 5 shows rings (10) aligned and ready to snap over line loading device (1) and into journals (11). Rings (10) can then be readily rotated around journals (11) such that the fishing line cannot slip through slot (12). Slot (12) is best seen in FIG. 7, where the ring (10) is shown separate from the line device (1). It is expressly understood that a single split ring is within the scope of the invention, and that the split ring or rings need not be journaled. In the case of a single split ring, the ring would extend substantially over the entire length of cylindrical rod (1)

It is important that helical groove (3) be sufficiently deep to extend below rings (10) to enable the fishing line to pass under rings (10) when the line loading device is in use. A depth of ⅛ inch to ¼ inch has been found particularly functional.

Either embodiment of FIG. 1 or FIG. 4 can be attached to the fishing rod without removing the fishing line from the fishing rod guides. That is, the embodiment of FIG. 1) with a simple helical groove (3) can be attached to the fishing rod while fishing enabling the fisherman to immediately untwist a line that has become unmanageable through repeated winding onto the spinning reel. In this way, the device can be used to untwist fishing line during a fishing excursion at any time desired.

It has also been discovered that the device can be used with no clamping mechanism. A simple elongated body with a helical groove can be manually held while reeling line onto the spinning reel. When used in this manner, the tension in the fishing line maintains the fishing line in the helical groove.

It is also contemplated that the fishing line can be pulled across the helical groove of the device without the aid of a fishing reel. For instance, the fishing line can be laid over the ground, and pulled through the helical grooves. The use of the invention in this manner is fully within the scope of the invention.

To use the device simply align the opening in the snap ring to expose the groove in the shaft. Wrap the line into the grooves on the shaft, then rotate the opening in the snap ring one-quarter to one-half turn. Attach the apparatus to the first guide on the rod and retrieve the line onto the reel. Depending on the amount of twist on the line the procedure may need to be repeated.

The line loading device may be machined or molded in any conventional manner. Polymer or metal, or even wood is useful to manufacture the cylindrical rod (1). Rings (6) and (7) could be made from metal or resilient plastic, as well as split rings (10).

1. A device to remove twist from fishing line while fishing line is retrieved onto a spinning reel, the device comprising an elongated rod with a distal end and a proximal end including a helical groove extending around the elongated rod, from the distal end to the proximal end, such that when fishing line passes around the helical groove, twisting the fishing line in an equal and opposite manner from the twist imparted by the rotation of the spinning reel, thereby removing twist from the line.

2. The device of claim 1 further including at least one split ring adapted to overlie the elongated rod and the helical groove, thereby enabling the fishing line to be secured in the helical groove between the elongated rod and the split ring.

3. The device of claim 2 wherein the elongated rod has at least one journal and the least one split ring is adapted to snap into the at least one journal, over the elongated rod, and wherein the helical ring is deeper than the journal, enabling the fishing line to pass between the split ring and the elongated rod.

4. The device of claim 1 further including a hook attached to the proximal end of the device whereby the device can be removably secured to a fishing rod, enabling a user to remove twist in fishing line while engaged in fishing.

5. The device of claim 1 wherein the elongated rod is cylindrical.

6. The device of claim 2 wherein at least two split rings and two journals are included.

7. The device of claim 1 including two removable clamps adapted to surround the cylindrical rod and the fishing rod thereby securing the device to a fishing rod, while simultaneously securing the fishing line in the helical groove between the removable clamps and the cylindrical rod, further including a slot in each of the two clamps that enable fishing line to pass between the two clamps and the cylindrical rod, wherein fishing line can be retrieved over the cylindrical rod without removing the fishing line from the rod guides.

8. A device to remove twist from fishing line while fishing line is retrieved onto a spinning reel, in combination with a fishing rod, comprising a fishing rod and a device including an elongated rod with a distal end and a proximal end including a helical groove extending around the elongated rod, from the distal end to the proximal end, such that when fishing line passes around the helical groove, twisting the fishing line in an equal and opposite manner from the twist imparted by the rotation of the spinning reel, thereby removing twist from the line.

9. The device of claim 8 further including at least one split ring adapted to overlie the elongated rod and the helical groove, thereby enabling the fishing line to be secured in the helical groove between the elongated rod and the split ring.

10. The device of claim 9 wherein the elongated rod has at least one journal and the at least one split ring is adapted to snap into the at least one journal, into the elongated rod, and the helical ring is deeper than the journal, enabling the fishing line to pass between the split ring and the elongated rod.

11. The device of claim 8 further including a hook attached to the proximal end of the device whereby the device can be removably secured to a fishing rod, enabling a user to remove twist in fishing line while engaged in fishing.
